(19) United States
(12) Patent Application Publication
(10) Pub. No.: US 2009/0119420 A1
(43) Pub. Date: May 7, 2009

(54) APPARATUS AND METHOD FOR SCALEABLE EXPANDERS IN SYSTEMS MANAGEMENT

(75) Inventor: Carl A. Morrell, Cary, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/935,829

(22) Filed: Nov. 6, 2007

(51) Int. Cl. G06F 3/00

(52) U.S. Cl. 710/9

(57) ABSTRACT

Embodiments of the present invention provide a method, system and computer program product for generating scalable addressing for expansion units. The method, system and computer program product for generate scalable addressing for an expansion unit is provided. The method, system and computer program product can include detecting a multiplexer of an expansion unit via a serial bus (e.g., an I2C bus), setting an address for the multiplexer of the first expansion unit, and upon accessing the multiplexer, switching the multiplexer to a first position to pass the serial bus to a second expansion unit to detect a multiplexer of the second expansion unit. The method can further include attempting to access the multiplexer of the second expansion unit and upon accessing the multiplexer of the second expansion unit, incrementing the address of the multiplexer of first expansion unit to set the address for the multiplexer of the second expansion unit.

### BACKGROUND OF THE INVENTION

1. Field of the Invention

The present invention relates to the field of computer systems management and more particularly to providing position dependant input/output (I/O) addresses for a communication bus to provide scaleable expansion units.

2. Description of the Related Art

Many similarities exist between seemingly unrelated designs in consumer, industrial and telecommunication electronics. Examples of similarities include intelligent control, general-purpose circuits (e.g., LCD drivers, I/O ports, RAM) and application-oriented circuits. The Inter-Integrated Circuit (I2C) bus is a bi-directional two-wire serial bus designed to exploit these similarities.

Devices on the I2C bus are accessed by individual addresses, 00-FF (typically, even addresses for Writes, odd addresses for Reads). The I2C architecture can be used for a variety of functions. One example is Vital Product Data (VPD). Each component in the system can contain an Electrically Erasable Programmable Read Only Memory (EEPROM) that which contains the VPD information such as serial numbers, part numbers, engineering change revision level, etc.

I2C buses can connect a number of devices simultaneously to the same pair of bus wires. Normally, the device addresses on the I2C bus are predefined by hardwiring on the circuit boards. A limitation of the I2C bus is that it will only allow a single device (e.g., an expansion board) to respond to each even address between 00 and FF. All addresses are even because only the high-order seven bits of the address byte are used for the address. Bit 0 is used to indicate whether the operation is to be a read or a write. Therefore, there are a limited number of addresses that can be assigned to a device.

Many I2C devices have their high-order four address bits predefined. The remaining three address bits are assigned with the use of strapping pins on the device. For example, most I2C accessible EEPROMs have three strapping pins that limit their addresses to the even addresses between A0-AF. This provides eight unique addresses for a given chip of that type. Thus, only eight of these devices may be connected to a single bus and still each have a unique address.

The addressing problem is exemplified by the current I2C designs for deploying expansion boards in a server blade computer, e.g. a blade server. For example, current I2C designs require explicit hard-wired individual buses for each expansion board deployed. As the number of expansion boards increases, the pin count of the expansion board connector must increase. In addition, such I2C designs prohibit the use of multiple identical expansion boards.

### BRIEF SUMMARY OF THE INVENTION

Embodiments of the present invention address deficiencies of the art in respect to expansion units of computer servers and provide a novel and non-obvious method, device and computer program product for generating scaleable addressing for expansion units. In one embodiment of the invention, a method to generate scaleable addressing for an expansion unit is provided. The method can include detecting a multiplexer of an expansion unit via a serial bus (e.g., an I2C bus), setting an address for the multiplexer of the first expansion unit, and upon accessing the multiplexer of the first expansion unit, switching the multiplexer to a first position to pass the serial bus to a second expansion unit, and detecting a multiplexer of the second expansion unit. The method can further include attempting to access the multiplexer of the second expansion unit and upon accessing the multiplexer of the second expansion unit, incrementing the address of the multiplexer of first expansion unit to set the address for the multiplexer of the second expansion unit and thus the address for second expansion unit.

In another embodiment of the invention, an address management device configured for address control of expansion units is provided. The device can include an expansion unit connector board in communication with a service processor and coupled to one or more expansion unit boards. Each expansion unit can include an address adder and an I2C multiplexer. The system also can include address processor logic. The logic can include program code enabled to detect a multiplexer of a first expansion unit via the serial bus, to set an address for the multiplexer of the first expansion unit, to switch the multiplexer of the first expansion unit to pass the serial bus to a second expansion unit, to detect a multiplexer of the second expansion unit, and upon accessing the multiplexer of the second expansion unit, to set an address for the multiplexer of the second expansion unit.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system that includes a chassis/slot, an input/output (I/O) expansion adapter and an address management device;

FIG. 2 is a schematic illustration of an address management device configured for address control of expansion units; and,

FIG. 3 is a flow chart illustrating a process to provide scaleable addressing of expansion units for the data processing system of FIG. 1.

### DETAILED DESCRIPTION OF THE INVENTION

Embodiments of the present invention provide a method, system and computer program product for generating scalable addressing for expansion units in data computing systems. In accordance with an embodiment of the invention, scalable addressing for expansion units is provided. The scalable addressing can be generated by detection of an expansion unit via a serial bus (e.g., I2C bus) to set an address for the first expansion unit. The detection of the expansion unit is related to an attempt to access a multiplexer associated with the expansion unit. Once the multiplexer of the first expansion unit is accessed, the multiplexer can be switched to a first position to pass the serial bus to a second expansion unit. Notably, once the multiplexer of the second expansion unit is detected and accessed, an address for the second expansion unit can be determined by incrementing the address of the multiplexer of first expansion unit to set the address for the multiplexer of the second expansion unit and thus the address for second expansion unit. Scalable addressing for additional expansion units can be determined by iterating this process.

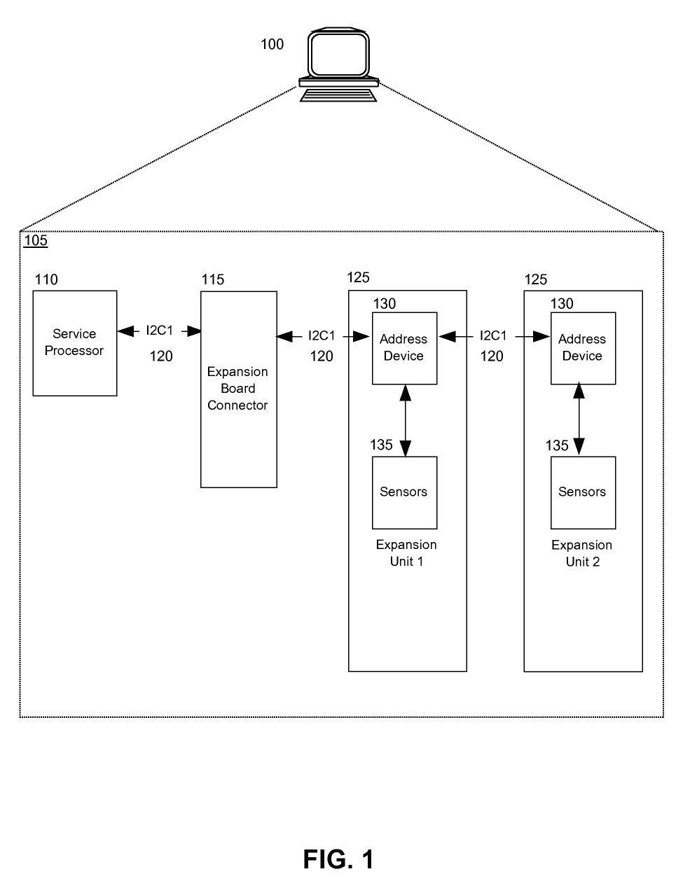

In illustration, FIG. 1 is a schematic of data processing system that includes a chassis/slot, an input/output (I/O) expansion adapter and an address management device. Data processing system 100, e.g., a blade server, is depicted that can include a chassis/slot 105, a service processor 110, an expansion board connector 115, a serial bus 120, e.g., an I2C bus, and multiple expansion units or options 125. In one embodiment, data processing system 100 employs an I2C bus architecture. The I2C bus 120 is a bidirectional serial bus requiring only two wires: serial data line (SDA) and serial clock line (SCL). Although serial buses do not have the throughput capability of parallel buses, serial buses require less wiring and fewer Integrated Circuit (IC) connector pins. Each device (service processor 110, expansion board connector 115, address management device 130, sensors 135 and any other I2C compatible devices) connected to I2C bus 120 is software addressable by a unique address. These devices can operate as either transmitters or receivers.

All I2C bus compatible devices have an on-chip interface which allows the devices to communicate directly with each other via the I2C bus 120. A simple master/slave relationship exists at all times. A master is a device which initiates a data transfer and the clock signals to permit the transfer, and any device addressed at the time of transfer is considered a slave. The I2C bus 120 is a multi-master bus, meaning more than one device capable of controlling the bus can be connected to it. However, the present implementation is operated in a single-master mode. The expansion units 125, the expansion board connector 115 and the service processor 110 are communicatively linked to the other over the serial bus 120.

Service processor 110 can include an operating system that supports the operation of address management logic configured to process expansion unit data and identify addressing for expansion units 125. Address management logic can include program code enabled to detect a multiplexer of a first expansion unit via the serial bus, to set an address for the multiplexer of the first expansion unit, to switch the multiplexer of the first expansion unit to pass the serial bus to a second expansion unit, to detect a multiplexer of the second expansion unit, and upon accessing the multiplexer of the second expansion unit, to set an address for the multiplexer of the second expansion unit.

Although the depicted representation shows a blade server, other embodiments of the present invention may be implemented in other types of data processing systems, such as a network computer.

In accordance with an embodiment of the present invention, each expansion unit or option 125 can include address management device 130. Address management device 130 is configured for address control of expansion units 125. The address management device 130 can be coupled to an expansion unit 125 and in communication with a service processor and expansion board connector 115 via the I2C bus 120.

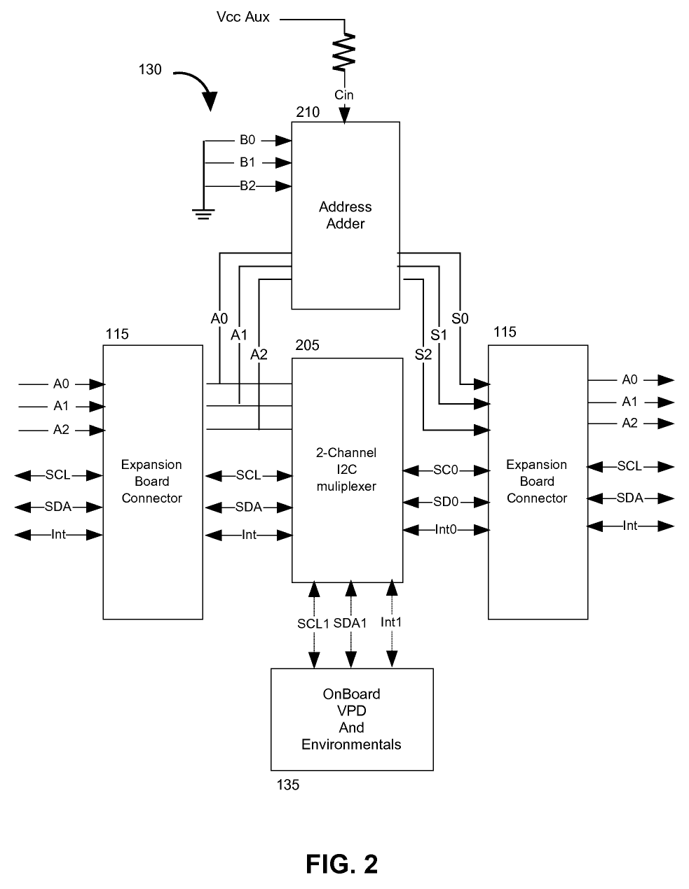

In further illustration, FIG. 2 is a schematic illustration of an address management device 130 configured for address control of expansion units 125. The address management device 130 can include a multiplexer 205 and an address adder 210. As illustrated in FIG. 2, on the expansion board connector 115 there are, in addition to the three I2C related signals SCL, SDA, and Interrupt, three additional addressing signals, A0, A1, and A2. Signals A0, A1, and A2 are used to set the I2C multiplexer address and thus the expansion unit addresses.

The address adder 210, e.g., IC 74HCT583, functions to take the three address signals A0, A1 and A2 and add one to the address. The new address is then passed on to the next expansion unit. The address adder 210 is configured so that one operand (e.g., B0, B1, B2) has a numerical value of zero (0) and a carry-in operand (e.g., Cin) has numerical value of one (1) to provide a unique I2C address for each expansion option multiplexer. In another embodiment, the adder function could be swept into a Complex Programmable Logic Device (CPLD) or other logic chip.

A 2-channel I2C multiplexer 205 is switched to one of two positions. One position passes the I2C bus 120 to a next expansion unit 125. The other position is used to access first expansion unit information via the onboard I2C devices, which can include, but not be limited to Vital Product Data, local NVRAM, and temperature and voltage sensors 135. Different types of expansion units 125 can be scaled as long as the address management circuit 130 is implemented. Notably, this design does not preclude the use of an entire expander topology within an individual expansion unit 125 as well.

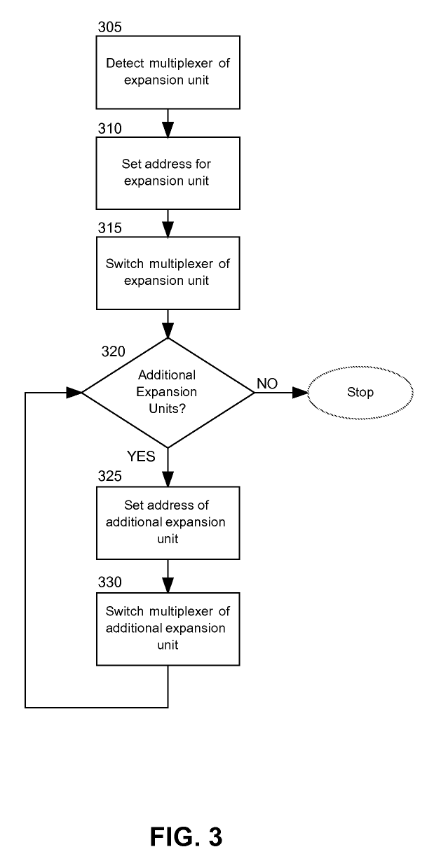

In further illustration, FIG. 3 is a flow chart illustrating a process to generate scaleable addressing for expansion units for the data processing system of FIG. 1. Beginning in block 305, an attempt to access a multiplexer of a first expansion unit is performed. In block 310, addressing processor logic is used to set an address for the first expansion unit 125 by setting the address of the multiplexer 205 of the first expansion unit 125. In block 315, the multiplexer 205 of the first expansion unit 125 is switched to pass the serial bus signal to a second expansion unit 125. At decision block 320, the presence of the second expansion unit 125 is determined by attempting to access the multiplexer 205 of the second expansion unit 125. If the attempt to access the multiplexer 205 of the second expansion unit 125 is unsuccessful, the iterative process stops as no second expansion unit 125 is deemed present.

On the other hand, if the attempt to access the multiplexer 205 of the additional expansion unit 125 is successful, then at block 325 the address of the additional multiplexer 205 is determined by incrementing the address for the multiplexer 205 of the previous expansion unit 125. In block 330, the multiplexer of the additional expansion is switched such that the I2C bus is passed on to the next expansion unit, if any remain. The process returns to decision block 320 to determine if there are any additional expansion units that remain and require addressing. This process continues until there are no remaining expansion units or the maximum number of addressable expansion units is reached for the I2C bus.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for generating scaleable addressing for expansion units, the method comprising:
detecting a multiplexer of a first expansion unit via a serial bus;
setting an address for the multiplexer of the first expansion unit;
switching the multiplexer of the first expansion unit to pass the serial bus to a second expansion unit;
detecting a multiplexer of the second expansion unit; and
upon accessing the multiplexer of the second expansion unit, setting an address for the multiplexer of the second expansion unit.

2. The method of claim 1, wherein detecting a multiplexer of a first expansion unit via a serial bus, comprises attempting to access the multiplexer of the first unit via an I2C bus.

3. The method of claim 1, wherein setting an address for the multiplexer of the second expansion unit, comprises incrementing the address of the multiplexer of the first expansion unit.

4. The method of claim 1, further comprising retrieving expansion board information from non-volatile memory on the first expansion board.

5. The method of claim 1, further comprising retrieving environmental information from a sensor on the first expansion board.

6. An address management system configured for scalable addressing of expansion units, the system comprising:
an address device coupled to an expansion unit and a serial bus; and,
address processor logic comprising program code enabled to detect a multiplexer of a first expansion unit via the serial bus, to set an address for the multiplexer of the first expansion unit, to switch the multiplexer of the first expansion unit to pass the serial bus to a second expansion unit, to detect a multiplexer of the second expansion unit, and upon accessing the multiplexer of the second expansion unit, to set an address for the multiplexer of the second expansion unit.

7. The address management system of claim 6, wherein the address device comprises:
a multiplexer coupled to the first expansion board and an I2C bus; and
an address adder coupled to the first expansion board and the I2C bus.

8. The address management system of claim 7, wherein the address adder is configured such that one operand has a numerical value of zero and a carry-in operand has numerical value of one.

9. A computer program product comprising a computer usable medium embodying computer usable program code for generating scalable addressing for expansion units, the computer program product comprising:
computer usable program code for detecting a multiplexer of a first expansion unit via a serial bus;
computer usable program code for setting an address for the multiplexer of the first expansion unit;
computer usable program code for switching the multiplexer of the first expansion unit to pass the serial bus to a second expansion unit;
computer usable program code for detecting a multiplexer of the second expansion unit; and
upon accessing the multiplexer of the second expansion unit, computer usable program code for setting an address for the multiplexer of the second expansion unit.

10. The computer program product of claim 9, wherein the computer usable code for detecting a multiplexer of a first expansion unit via a serial bus, comprises computer usable code for attempting to access the multiplexer of the first unit via an I2C bus.

11. The computer program product of claim 9, wherein the computer usable code for setting an address for the second expansion unit, comprises computer usable code for incrementing the address of the multiplexer of the first expansion unit.

12. The computer program product of claim 9, further comprising computer usable code for retrieving expansion board information from non-volatile memory on the first expansion board.

13. The computer program product of claim 9, further comprising computer usable code for retrieving environmental information from a sensor on the first expansion board.
